(19) United States
(12) Patent Application Publication
(10) Pub. No.: US 2009/0091233 A1
(43) Pub. Date: Apr. 9, 2009

(54) PROTECTING DEVICE FOR ELECTRONIC CIRCUIT AND MANUFACTURING METHOD THEREOF

(76) Inventor: Liu Te-Pang, Chunan (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/866,567

(22) Filed: Oct. 3, 2007

(51) Int. Cl. H01J 1/88; B05D 5/12

(52) U.S. Cl. 313/243; 427/77; 257/E21.477

(57) ABSTRACT

Disclosed is a protecting device for electronic circuit and the manufacturing method thereof. The device is a multi-layered structure which includes a dielectric layer and several electrode layers overlapping in the inner circumference of the substrate. After making up a whole structure, a transverse gap with an appropriate depth is formed by cutting process causing two superposed electrode layers to split into two parts facing to each other with respect to the transverse gap and also split into upper and lower parts with respect to the dielectric layer. With this structure, the gap can serve as a protecting element for electrostatic discharge (ESD) or other elements by filling different materials and with the aid of the dielectric layer of appropriate thickness thereby the whole structure can be used to perform surge protection for various electronic circuits.

### BACKGROUND OF THE INVENTION

1. Field of the Invention

The present invention relates to a protecting device for electronic circuit and manufacturing method thereof, especially, to a protecting device for an electronic circuit having electrode layers formed on a substrate extending from the two sides of the substrate to its central part with a dielectric layer is interposed therebetween, and a transverse gap is formed by cutting process resulting in a structure that the dielectric layer divides the electrode layers into upper and lower parts and the two electrode parts are respectively separated by the transverse gap. Thus, an electro-static discharge path are formed between the upper and lower electrodes so as to obtain the circuit elements having functions of protecting electronic circuit from a surge voltage.

2. Description of the Prior Art

It is known to public that capacitor, resistor, and inductor are three indispensable passive circuit elements of an electronic device. The capacitor, which is formed by intercalating with a dielectric substance between two conducting materials, performs the function of storing electrical energy, and serves as a filter, modulator or oscillator. The capacitor is classified in the categories as a fixed, variable and crystal capacitor by different dielectric substances.

The resistor performs the function of regulating the circuit voltage and current. The inductor serves to filter out the noise of the current so as to eliminate the magnetic interference. Three of them are associated one another to control the electronic circuits in the field of information, communication, electronic appliances, and other electronic industries.

In the circuit of electronic communication, an abnormal voltage caused by the electro-static discharge (ESD) may cause a severe damage to the components of the electronic equipment such as a substrate and which further extends to the loss of the whole electronic product. Generally, the electronic apparatus employs the combination of said passive elements (resistor, capacitor, inductor) to protect the electronic products from the attack of the surge voltage arising from ESD.

Among those ESD protecting devices are Transient Voltage Suppress Diode (TVSD), Multi-Layer Varistor (MLV) etc, while the means for protection of the electronic circuit are shielding, gap discharge, and charging and discharging functions of capacitor etc.

For protecting the electronic apparatus from ESD attack, in a PCB layout, a gap discharge electrode shown in FIG. 1A is provided directly at the place where the ESD protection is needed, and this is included simultaneously during the fabrication of a PCB so as to lower the production cost.

In FIG. 1A, on a PCB substrate 10, a circuit 11 on which an acute discharge electrode 12a is formed to serve as an ESD protection means, an a gap 13 is interposed between the discharge electrode 12a and the other grounded acute discharge electrode 12b.

Referring to FIG. 1B together with FIG. 1A, when an abnormal voltage induced by a surge 15 appears at a circuit 11 with an energy represented by ESD curve 16, The break down occurs in the gap 13 between the electrodes 12a and 12b, therefore the amplitude of the abnormal voltage should be limited in an acceptable range as shown in curve 17 to protect the circuit 11.

However, after a careful study, the aforesaid protecting aspect is deemed incomplete as it has the following shortcomings:

(1) The gap 13 which is formed by mechanical cutting can not achieve the necessary scale sufficient to protect the surge of ESD.

(2) As the width of the gap 13 can not reach the required scale, the break down voltage will become high and then is not possible to protect the electronic circuit and device.

For these defects noticeable on the prior art, an improvement is seriously required. The inventor has dedicated great efforts for years to studying and improving these defects and come up with a novel protecting device for electronic circuit and manufacturing method thereof as provided in this invention.

### SUMMARY OF THE INVENTION

Accordingly, the present invention has been made to solve the above-mentioned problems occurring in the prior art, and an object of the present invention is to provide a protecting device for electronic circuit and manufacturing method thereof such that the electronic circuit can be protected from being damaged due to a surge voltage.

In order to accomplish the object, there is provided a method of manufacturing a protecting device for electronic circuit to form a stacked structure on a substrate, and to form a dielectric layer thereof using the printing process, and cutting a gap thereof. By utilizing materials of different properties for the dielectric layer, a protecting device can be produced which is able to protect an electronic circuit involving various kinds of resistor, capacitor, and inductor. While the gap may become a protecting element for ESD. by filling a piezoelectrically sensitive material or various gases etc. therein, and then to serve as an element having function of preventing the electronic apparatus from damage by ESD.

According to the protecting device for electronic circuit and manufacturing method of present invention, a multi-layered structure is formed which includes a dielectric layer and severed electrode layers overlapping one another in the inner circumference of the substrate. After making up a whole structure, a transverse gap with an appropriate depth is formed by cutting process which causes two superposed electrode layers to split into two parts facing to each other with respect to the transverse gap, and also split into upper and lower parts with respect to the dielectric layer. With this structure, the gap can serve as a protecting element for ESD by filling different kinds of materials and with the aid of the dielectric layer of appropriate thickness thereby the whole structure can be used to perform protection for various electronic circuits.

According to another embodiment of the protecting device for electronic circuit and manufacturing method of present invention, after the electrode layers are formed, a plurality of separated monomer electrodes along the same direction are obtained. Then a transverse gap is formed by the cutting process so as to make each of the said monomer electrode becomes a pair of electrodes having electrodes to face against one another frontward and backward, upward and downward due to the formed transverse gap. Thus a matrix configuration is established in which the plurality of horizontally and vertically arrayed separate monomer electrodes are include thereby forming an arrayed protecting device for ESD.

According to the protecting device for electronic circuit and manufacturing method of present invention, the distance between the upper and the lower electrode layers is determined by the thickness of the dielectric layer formed by printing process. Accordingly, the high difference between the upper electrode layer and the lower electrode layer can be controlled as small as possible so as to prevent an unappropriate breakdown voltage caused by an improper gap width.

According to the protecting device for electronic circuit and manufacturing method thereof, the structure of the protecting device is made very simple while having versatile performance, and can be made up with a low production cost.

The above aspects, and other features and advantages of the present invention will become more apparent after a reading of the following detailed description when taken in conjunction with the drawings, in which:

### BRIEF DESCRIPTION OF THE DRAWINGS

FIG. 1A is a schematic view showing the structure of a conventional gap discharging device;

FIG. 1B shows discharge voltage suppressing curve according to the conventional techniques;

FIG. 2A through 2F are the plane and side views for illustration of the manufacturing method according to the present invention;

FIG. 3 is an exploded three dimensional view illustrating the manufacturing method according to a second embodiment of the present invention;

FIG. 4 is a three dimensional assembly view according to a second embodiment of the present invention;

FIG. 5 is a cross sectional view according to a second embodiment of the present invention;

FIG. 6 is a cross sectional view according to a third embodiment of the present invention.

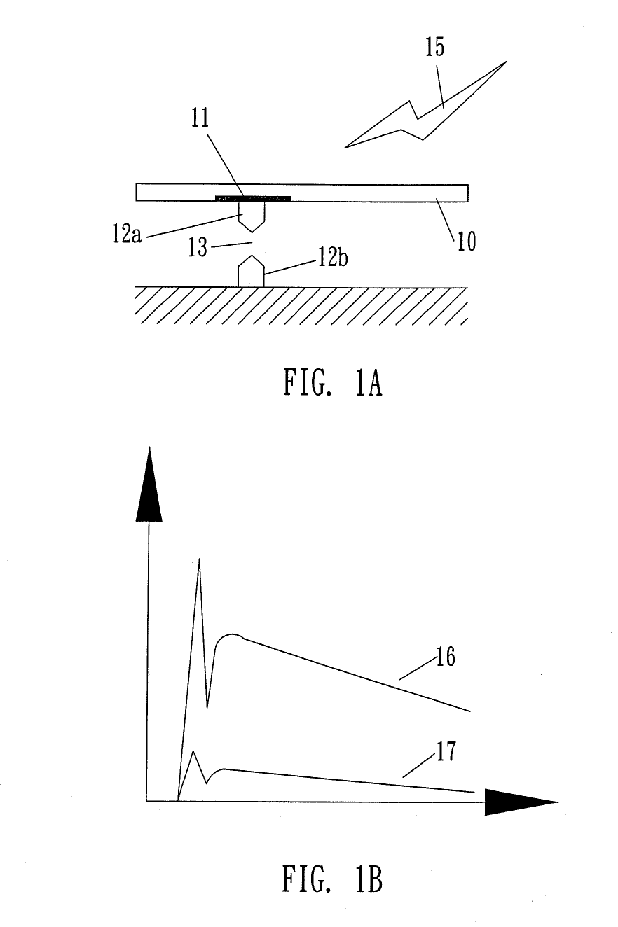

### DETAILED DESCRIPTION OF PREFERRED EMBODIMENTS

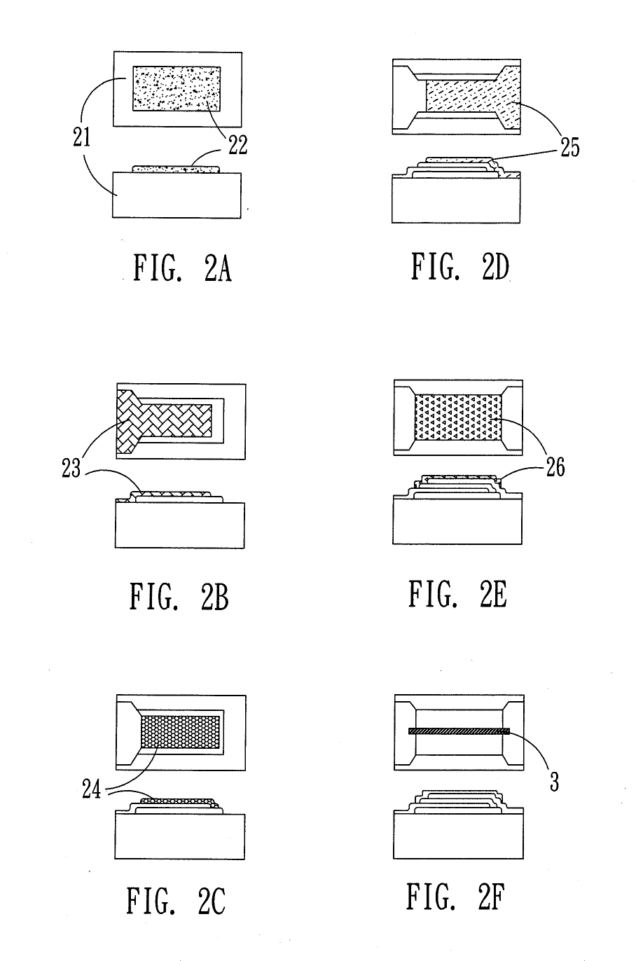

As shown in FIG. 2A through 2F, the manufacturing method of the protecting device for electronic circuit of present invention includes the following steps of:

1. Forming a glass foundation 22 on the surface of a ceramic substrate 21, wherein the glass foundation 22 is positioned on the central part of the ceramic substrate 21 to avoid contacting it edges with that of the ceramic substrate 21 (please refer to FIG. 2A);

2. Forming a first electrode layer 23 to cover the glass foundation 22, one side of the first electrode layer 23 is connected with a first side of the ceramic substrate 21, while the other side thereof is partially covering the upper surface of the glass foundation 22 (please refer to FIG. 2B);

3. Forming a dielectric layer 24 having the area approximately equal to that of the glass foundation 22 to cover the first electrode layer 23 at a position right on the glass foundation 22, one side of the dielectric layer 24 is connected to one side of the glass foundation 22 (please refer to FIG. 2C);

4. Forming a second electrode layer 25 to cover the dielectric layer 24, one side of the second electrode layer 25 is connected to a second side of the ceramic substrate 21, while the other side of the second electrode layer 25 is partially covering the upper surface of the dielectric layer 24 (please refer to FIG. 2D);

5. Forming a protecting glass layer 26 to cover the second electrode layer 25, one side of the protecting glass layer 26 is connected to the dielectric layer 24 (please refer to FIG. 2E);

6. Finally, by cutting process with a diamond blade or by laser trimming process to cut out in the transverse direction a gap 3 along the overlapped portion of the first electrode layer 23, the dielectric layer 24 and the second electrode layer 25. The transverse gap 3 passes through the protecting glass layer 26, the second electrode layer 25, the dielectric layer 24, the first electrode layer 23 and the glass foundation 22 such that the aforesaid five layers are each split into two front and rear parts facing to each other (please refer to FIG. 2F);

With this structure, the thickness of the dielectric layer 24 intercalated between the first and second electrode layers 23, 25 serves a discharge gap so that the whole structure becomes a surge protecting device. Further more, the first electrode layer 23 and the second electrode layer 25 are respectively split into a first front electrode layer 231 facing to a first rear electrode layer 232, and a second front electrode layer 251 also facing to a second rear electrode layer 252 by the transverse gap 3. Then by filling the gap 3 with a piezoelectrics or gases (for example: an idle gas of He) of different properties, a FSD protecting device of different trigger voltage will result between the first front and the first rear electrode layers 231, 232, and between the second front and the second rear electrode layers 251, 252.

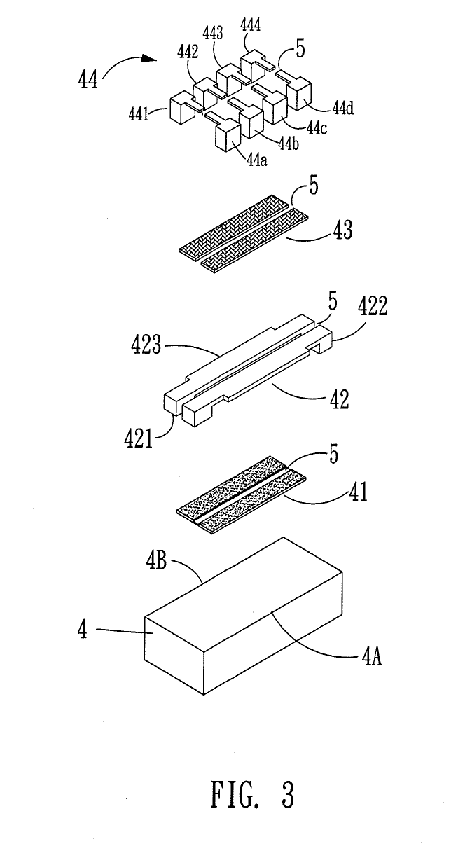

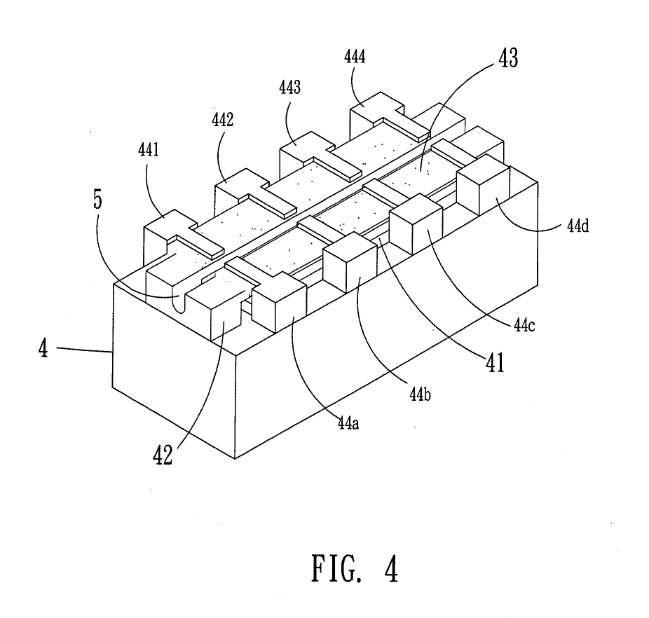

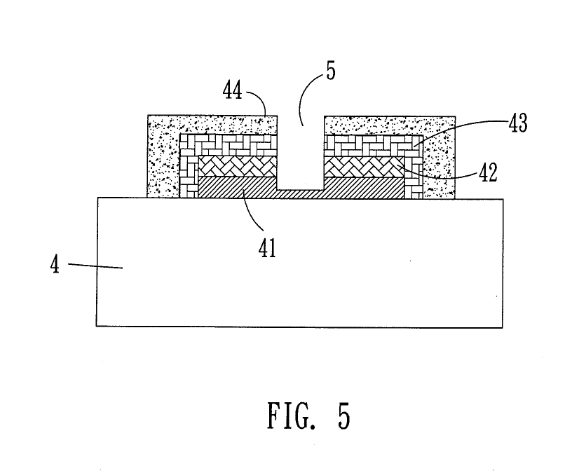

Referring to FIG. 3 through FIG. 5, the manufacturing method of the protecting device for electronic circuit according to another embodiment of the present invention includes the following steps of:

1. Preparing a ceramic substrate 4;

2. Forming a buffer layer 41 on the central part of the ceramic substrate 4 with a shape of rectangular parallelepiped elongated in the same direction with the ceramic substrate 4;

3. Forming a π shaped electrode material layer 42 having the same length with that of the ceramic substrate 4 to cover the buffer layer 41, the two ends thereof are formed into taller billets 421, 422 respectively positioned on the right and left sides of the buffer layer 41 and connected to the upper side of the ceramic substrate 4, the upper end thereof is formed into a flat surface 423 protruded sideward to form a cross bar like figure;

4. Forming a dielectric layer 43 to cover the electrode material layer 42;

5. Forming an electrode conductor layer 44 to cover the dielectric layer 42, the electrode conductor layer 44, which is made of a conducting material consisting of Pd or Pt, is covered partly on the electrode material layer 42. Several separately disposed monomer electrodes 441, 442, 443, 444 are provided along the longitudinal direction of the ceramic substrate 4, these monomer electrodes 441, 442, 443, 444 are formed at the upper and the lower sides so as to respectively located on the upper and lower sides of the dielectric layer 43, the electrode material layer 42 and the buffer layer 41 thereby enabling their upper and lower sides to respectively connect with the upper and lower sides 4A and 4B of the ceramic substrate 4;

6. Then afterwards, forming a protecting layer to cover the electrode conductor layer 44;

7. Finally, by the cutting process using a diamond blade or the laser trimming process, a transverse gap 5 is formed along the central part of the structure which passes through the electrode conductor layer 44, the dielectric layer 43, the electrode material layer 42, and partially pierces deeply into the buffer layer 41 so as to split the said layers 44, 43 and 42 into two (front and rear) parts facing to each other. Especially for the electrode conductor layer 44, it is divided into symmetrically separated front and rear monomer electrodes 441, 442, 443, 444 and lower monomer electrodes 44a, 44b, 44c, 44d.

With this structure obtained by the process described above, the dielectric layer 43, which is intercalated between the electrode conductor layer 44 and the electrode material layer 42, can be made by the thick film printing process to control its thickness as thin as possible, and further by employing various kinds of dielectric substance, and filling the transverse gap 5 with a piezoelectrically sensitive material, a perfect ESD protecting device can be obtained to protect the electronic circuit containing register, inductor, capacitor of different values.

The protecting device formed of plural monomer electrodes arrayed in a matrix pattern can be provided with a plurality of pins for connection with several circuits when used on a circuit board, while the billets 421, 422 formed at the two sides of the electrode material layer 42 can be used to serve as ground terminals. By doing this way, because of the fact that the dielectric layer 42 which will affect the characteristics of resistor and capacitor is able to be well controlled so that the conventional disadvantages of troubles to connect individually different protecting devices for different electronic circuits can be rectified, and through filling the gap 5 with a material to avoid lowering break down voltage that results in improving the surge protection and stability of the protected electronic circuit.

With the above mentioned steps to manufacture the protecting device, the electronic circuit will sure be well protected from the surge attack.

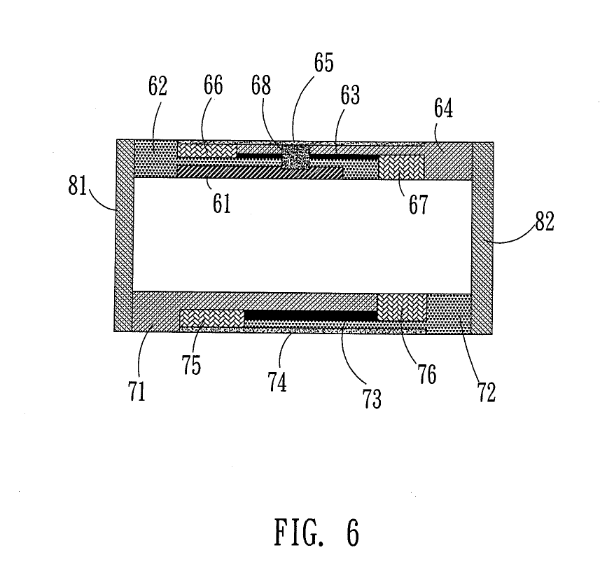

Referring to FIG. 6, according to one more embodiment of the present invention, a buffer layer 61. a first electrode layer 62, a dielectric layer 63, a second electrode layer 64, a protecting layer 65, a first insulation layer 66 and a second insulation layer 67 are sequentially formed on a substrate. By cutting process, a transverse gap 68 is formed to split the above layers into two parts facing to each other. Different gases and piezoelectrically sensitive materials are filled into the gap 68 by the technique of air discharging, so as to obtain the structure on the substrate having properties of the ESD protection. Meanwhile, by the thick film printing process, a first electrode layer 71, a second electrode layer 72, a dielectric layer 73, a protecting layer 74, a first insulation layer 75 and a second insulation layer 76 can be formed on the reverse surface of the substrate so as to obtain a similar structure as the former one to perform ESD protection. Afterward, by electroplating process, two external electrodes 81, 82 are provided on outside of the structure, and further forms a two-face protecting device for the electronic circuit by making an electrical connection between the upper and lower structures.

In the embodiment shown in FIG. 6, the upper part of the substrate may serve as an ESD protecting device while the lower part thereof may serve as a RC or EMI circuit therefore a two-functional structure, for example, a multi-functional device having ESD protection function and RC circuit, or, a multi-functional device having ESD protection function and EMI circuit, is realized.

The above mentioned resistor and capacitor arrayed in matrix pattern as a whole structure is able to play a roll of a versatile protecting device applicable to all electronic products so as to reduce the cost of circuit construction. It fulfills the requirements of light, thin, short and compact especially suitable for the high frequency or sophisticated electronic devices.

With multi-layered dielectric and electrode unit associated with a gap filled with a certain material, a structure containing various capacitors and resistors can be constructed to meet various requirement about abnormal voltage protection only varying the material filled in the gap.

The outstanding features of the present invention are as follows:

1. The gap width can be easily controlled at 10˜30 μm through diamond blade cutting or the laser trimming.

2. The vertically stacked structure facilitates controlling the gap width at 5˜25 μm through printing process.

3. Extremely minimized gap with aids to effectively bring down the break down voltage so as to improve the ESD protection for the low voltage device using a simply constructed protecting structure.

The above aspects, and other features and advantages of the present invention will become more apparent after a reading of the following detailed description when taken in conjunction with the drawings.

1. A protecting device for electronic circuit comprising:
a ceramic substrate;
a buffer layer formed on said ceramic substrate;
an electrode material layer formed on said buffer layer;
a dielectric layer formed on said electrode material layer;
a protecting layer formed on said electrode conductor layer;
characterized in that: a transverse gap is formed to pass through said electrode conductor layer, said dielectric layer and said electrode material layer and partially pierce deeply into said buffer layer so as to split said electrode conductor layer, said dielectric layer and said electrode material layer into two parts facing to each other.

2. The protecting device as claimed in claim 1, wherein said dielectric layer is a glass board.

3. The protecting device as claimed in claim 1, wherein said dielectric layer is made of a dielectric material.

4. The protecting device as claimed in claim 1, wherein said electrode conductor layer is formed of several separated monomer electrodes along the longitudinal direction of said ceramic substrate, and each monomer electrode is split by said transverse gap into two parts facing to each other.

5. The protecting device as claimed in claim 1, wherein said electrode material layer has several billets formed at both sides thereof for grounding.

6. The protecting device as claimed in claim 1, wherein said electrode material layer is formed into π shape.

7. The protecting device as claimed in claim 1, wherein said buffer layer, said electrode conductor layer, said electrode material layer and said protecting layer can be formed on the bottom surface of said ceramic substrate.

8. The protecting device as claimed in claim 1, wherein said buffer layer, said electrode conductor layer, said electrode material layer and said protecting layer are of the characteristic of the capacitor and the inductor, with their dielectric properties they are able to serve as a RC circuit or an EMI circuit.

9. A method of manufacturing a protecting device for electronic circuit comprising the steps of:
preparing a ceramic substrate;
forming a buffer layer on said ceramic substrate;
forming a first electrode conductor layer to cover said buffer layer;
forming a dielectric layer to cover said first electrode conductor layer;
forming a second electrode conductor layer to cover said dielectric layer;
and, forming a transverse gap which passes through said second electrode conductor layer, said dielectric layer and said first electrode conductor layer thereby splitting said second electrode conductor layer, said dielectric layer and said first electrode conductor layer into two parts facing to each other forward and backward.

10. A method of manufacturing a protecting device for electronic circuit comprising the steps of:
preparing a ceramic substrate;
forming a buffer layer on said ceramic substrate;
forming an electrode material layer to cover said buffer layer;
forming a dielectric layer to cover said electrode mater layer;
forming an electrode conductor layer to cover said dielectric layer, wherein said electrode conductor layer is provided with several separated monomer electrodes along the longitudinal direction of said ceramic substrate; and
forming a transverse gap passing through said electrode conductor layer, said dielectric layer and said electrode material layer thereby splitting said electrode conductor layer, said dielectric layer and said electrode material layer into two parts facing to each other forward and backward.

11. The protecting device as claimed in claim 5, wherein said electrode material layer is formed into π shape
